(19) United States
(12) Patent Application Publication
(10) Pub. No.: US 2021/0196074 A1
(43) Pub. Date: Jul. 1, 2021

(54) JUICING DEVICE AND METHOD FOR USE

(71) Applicant: JOGO Inc.

(72) Inventors: Ivan Guarin, Minneapolis, MN (US); Jon-Christopher Makai Catudio, St. Paul, MN (US); Amilcar Velho Caputo, Eagan, MN (US); Charles Fredric Steaderman, Burnsville, MN (US); Daniel Darst, Zimmerman, MN (US); Travis Charles Neumann, Plymouth, MN (US); Christopher Erik Svensrud, Minneapolis, MN (US)

(73) Assignee: JOGO Inc.

(21) Appl. No.: 15/672,769

(22) Filed: Aug. 9, 2017

Related U.S. Application Data
(60) Provisional application No. 62/372,530, filed on Aug. 9, 2016.

(51) Int. Cl. A47J 31/40; A47J 31/52; A47J 31/44; A23L 2/39; B01F 13/08; B01F 3/12; B01F 15/02; B01F 15/00

(52) U.S. Cl. CPC A47J 31/407; A47J 31/404; A47J 31/525; A47J 31/4492; A23L 2/39; B01F 2215/0022; B01F 3/1221; B01F 15/0251; B01F 15/00253; A23V 2002/00; B01F 13/0854

(57) ABSTRACT

A machine system and method provide to allow for the reconstituting of a powdered material into a juice blend. The machine including a cartridge having a cavity for the placement of the powder. The cartridge adapted to dispense the powder into a container for mixing with a fluid. The machine system including a controller and human machine interface allowing a user of the machine to customize and generally select the contents of more than one cartridge for the formation of beverage mixed from multiple beverages.

### CROSS REFERENCE TO RELATED APPLICATIONS

This application claims priority to U.S. Provisional Patent Application No. 62/372,530 filed 9 Aug. 2016 to the above named inventors, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present disclosure relates to an improved juicing device and method primarily designed to rehydrate powdered and concentrated fruit and vegetable powders into a liquid form for consumption.

### BACKGROUND OF THE INVENTION

Current solutions as they relate to the consumption of beverages containing a fruit or vegetable generally require the grating, squeezing, or compression of the fresh fruit or vegetable material to be juiced, wherein a pulp material is formed that is then centrifuged or further manipulated to extract a liquid component. This liquid component generally represents the juice of the fruit or vegetable.

To create a drinkable quantity of juice, several fruits or vegetables are needed during the process and a large amount of waste pulp is created. Generally, this freshly processed juice is perishable and required to be refrigerated or consumed within a small window of time.

### SUMMARY OF THE INVENTION

Anew and improved juice vending apparatus and methods of making a juice beverage are disclosed. The vending apparatus is generally provided to dispense a quantity of a powder into a specialized container where the powder material is reconstituted with a liquid component and mixed within the container. This mixture of liquid and powder forms a beverage resembling a juice. Accordingly, the vending apparatus is adapted to include a plurality of containers adapted to store various flavors of powders and wherein a user can select from this plurality of containers to create a blended beverage, wherein the beverage is formed from the powder of multiple containers.

The vending apparatus includes various internal systems and controls to enable the formation and mixture of the finished beverage. A first internal system relates to a fluid delivery system. This fluid delivery system includes a fluid source, such as a reservoir for the storage of water, and a heat exchanger adapted to cool the fluid to a desired temperature.

A second internal system relates to a dispensing assembly. This dispensing assembly includes a plurality of preassembled cartridges with a known quantity of powdered material and a carriage for otherwise securing and manipulating the cartridges within the apparatus. This carriage allows for the selection of various installed cartridges and enables the measured dispersal of a given cartridge into the container.

A third internal system relates to a blending assembly. The blending assembly is generally adapted to agitate the contents of the container allow for a dispersal of powder within the liquid and wherein the contents of the container are generally blended into a homogenous mixture. This blending assembly preferably includes a mechanical mixing device embedded within the container in a removable coupling with the apparatus.

A fourth internal system relates generally to the electronic and control features of the apparatus. The electronic and mechanical systems of the apparatus are generally engaged and controlled through a controller and human machine interface (HMI), wherein the interface is accessible by a user and adapted to allow for the selection of the dispersal of a powder from a given cartridge or multiple cartridge's. Accordingly, a user may select a beverage that is comprised of amounts of powder from different cartridges and reconstituted into a homogenous blended fruit or vegetable blend.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is an isometric view of the exterior of the juicing machine, according to the present invention;

FIG. 2 is an isometric view of several internal components of the juicing machine, according to the present invention; and

FIG. 3 is aside view of the internal components of the juicing machine, according to the present invention;

FIG. 4 is an isometric view of the dispensing system of the juicing machine, according to the present invention;

FIG. 5 is atop view of the dispensing system of the juicing machine, according to the present invention;

FIG. 6 is a cross sectional view of a preferred cartridge assembly, according to the present invention;

FIG. 7 is an isometric view of a vertical shaft member of the cartridge, according to the present invention;

FIG. 8 is an isometric view of a cartridge, according to the present invention;

FIG. 9 is an isometric view of an alternate embodiment for the cartridge, according to the present invention;

FIG. 10 is a side view of a container, according to the present invention;

FIG. 11 is an isometric view of a container, according to the present invention; and

FIG. 12 is a wire frame diagram of the systems of the juicing machine, according to the present invention;

### DETAILED DESCRIPTION OF THE INVENTION

The following detailed description includes references to the accompanying drawings, which forms a part of the detailed description. The drawings shows, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGS., with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

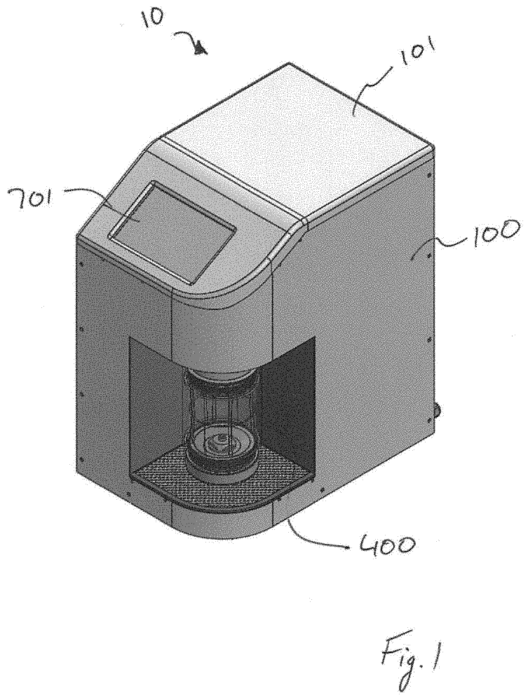

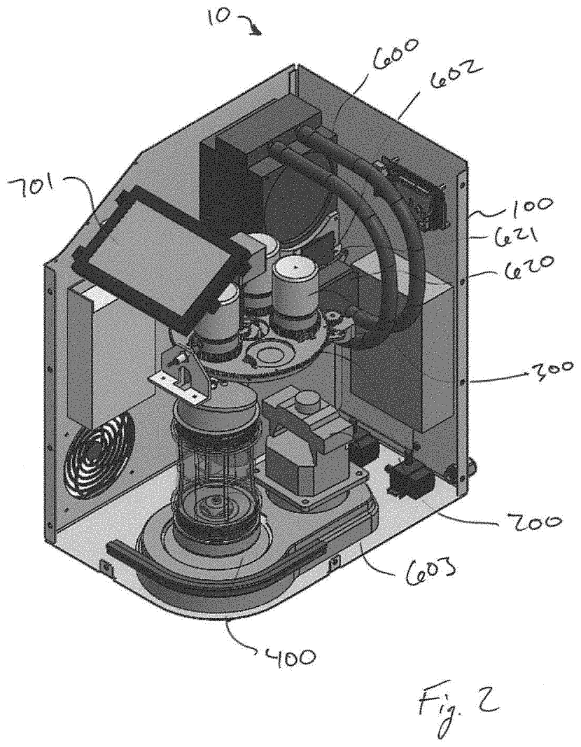

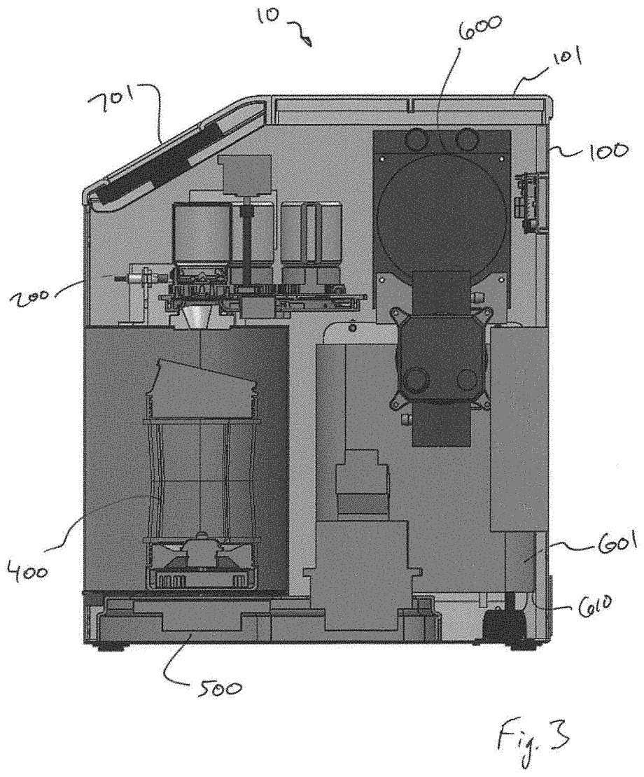

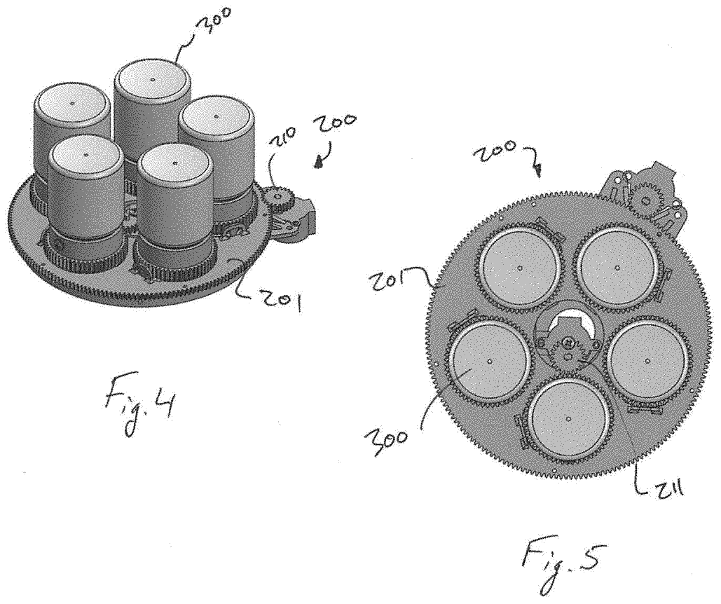

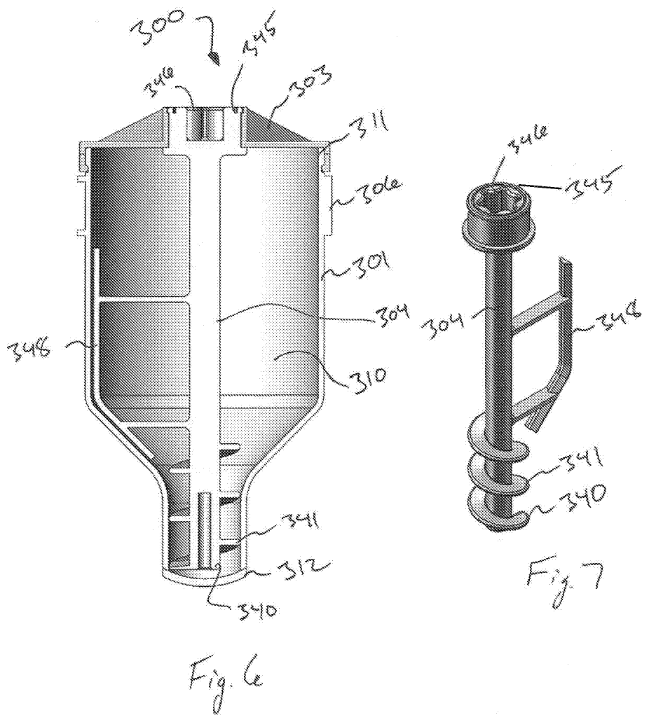

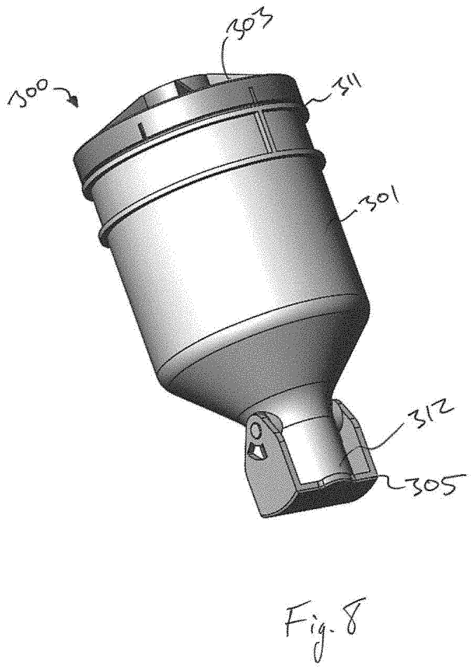

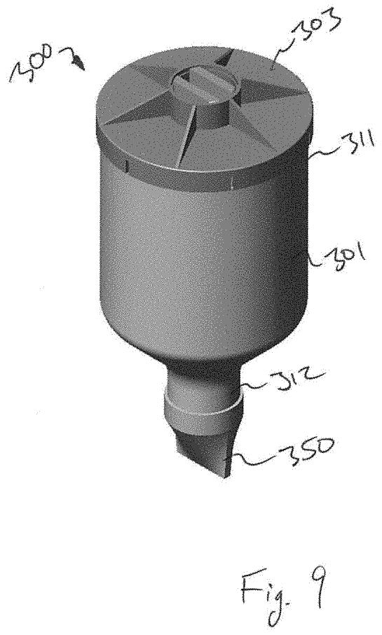

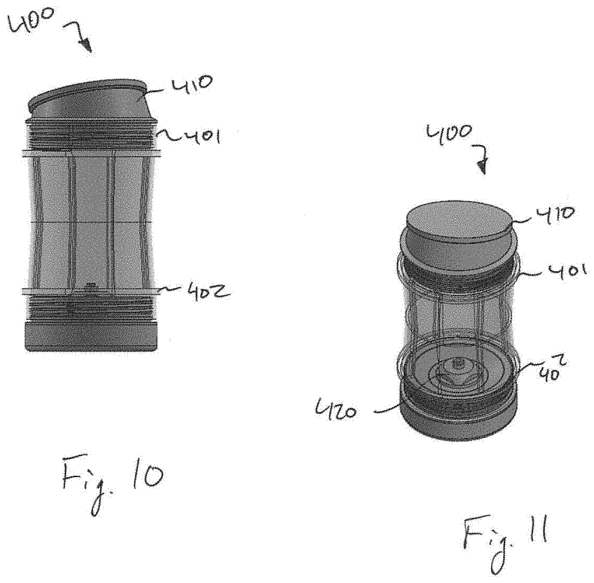

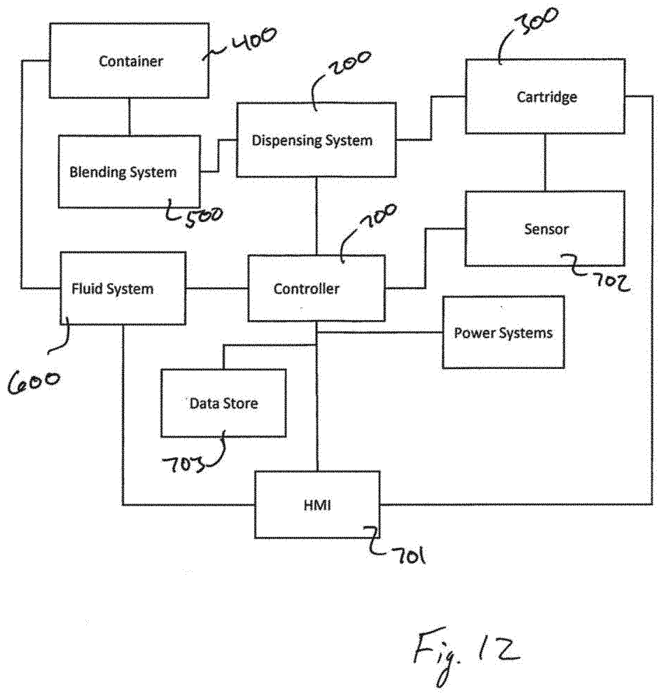

Referring now to FIG. 1-FIG. 12., the present disclosure relates an apparatus adapted as a juicing device and method for use of the device, generally referred to as device 10. The device 10 is designed to mechanically add a cooled fluid to a powdered concentrate form of various fruit types and vegetable types, wherein a user can select, through a human machine interface 701, various and multiple configurations and percentages of these powdered components to make a rehydrated juice beverage. The powdered contents are generally formed from the dehydration of fruits and vegetables and adapted to be reconstituted to a juice through the addition of a fluid and agitation.

The device 10 is generally comprised of main housing 100 adapted to enclose the various mechanical, electronic, electro-mechanical, and fluid systems of the device 10. Accordingly, this main housing 100 generally secures and protects these internal components with the exception of a cover portion 101 being removable and allowing a user access to the dispensing system 200 for the placement, removal, replacement, or repositioning of a cartridge 300.

The dispensing system 200 is adapted to receive a plurality of cartridges 300 and allows for rotational movement of the individual cartridges 300 and the rotational movement of the plurality of cartridges 300. Preferably, this dispensing system is a tray portion 201 having a generally planar surface and an outer diameter. The outer diameter having a plurality of teeth, the teeth adapted for intermeshed engagement with teeth of a drive gear 210, wherein the drive gear 210 rotates the tray portion 201.

The tray portion 201 including a central aperture, the central aperture adapted to allow for the placement of a dispensing drive gear 211. The dispensing drive gear 211 adapted for engagement with the cartridge 300, wherein the dispensing drive gear 211 is adapted for rotational engagement with the individual cartridges 300 for dispensing the contents of the cartridges 300.

The cartridges 300 are comprised of a housing 301 having generally cylindrical sidewalls defining a cavity 310 for the placement of a powdered material for dispensing. The housing 301 cavity 310 defined by an upper surface 311 defining an opening for access to the cavity and a lower surface 312 opposite the upper surface 311, the distance between the upper surface 311 and lower surface 312 defining a height of the cavity 310. The lower surface 312 having an opening with a diameter less than a diameter of the upper surface 311, wherein the housing 301 has a frustoconical shape to generally funnel the internal powdered contents towards the lower surface 312 opening.

The housing upper surface 311 is enclosed by a cap 303. The cap 303 sealing the upper surface 311 of the housing after the cavity is filled with the powdered contents, and wherein the cartridge 300 is generally a consumable item associated with the device 10. The cap 303 is configured and assembled to prevent the ingress of moisture into the cartridge 300 to prevent degradation, clumping, congealing, bridging, and ratholing of powder material during dispensing.

The cavity 310 of the cartridge 300 includes a vertical shaft member 304 rotationally received and centrally positioned within the cavity 310 in engagement with the lower surface 312 opening and the cap 303 and adapted to move powdered contents from the cartridge 300 and into a container 400. Accordingly, the vertical shaft member 304 has a first end 340 opposite a second end 345 defining a height of the vertical shaft member 304. The first end 340 including a helical screw blade 341 forming a screw conveyor to move the powdered contents towards the lower surface 312 opening during rotation of the vertical shaft member 304. The second end 345 is generally disposed through the cap 303 and including a notched recessed portion 346 sized and shaped to receive a corresponding tool portion of the dispensing drive gear 211.

The vertical shaft member 304 including an arm portion 348 radially spaced outward a distance opposite the central position of the cavity 310 from the vertical shaft member 304 and generally shaped to conform to cavity 310 sidewalls. The arm portion 348 configured to generally agitate, move, and stir the powdered contents of the cavity 310 during rotation of the vertical shaft member 304. The arm portion 348 is preferably configured with a similar shape to the frustoconical shape of the cartridge 300, wherein the arm portion 348 is able to contact the majority of the volume of the cavity 310 during rotation.

The lower surface 312 of the cartridge 300 exterior includes a gate valve 305 adapted to allow for the release of the powdered contents of the cavity 310 into the container 400. The gate valve 305 adapted to be operated by the device 10 controller 700 when needed for dispensing. The gate valve 305 may be coupled with a releasing valve (not pictured) wherein the releasing valve is only opened when the cartridge 300 is placed within the device 10 to prevent the release of the internal powdered contents of the cartridge 300 when not placed into the dispensing system 200.

The cartridge 300 further includes an identification means 306 allowing at least for the identification of the cartridge type (i.e. flavor/type of juice) placed within the device 10 for reading by a sensor 702 in communication with a controller 700. The identification means is preferably embedded within the cartridge 300 and utilizing, radio frequency identification (RFID), electronically erasable programable read only memory (EEPROM), or other similar electronically readable identification system. The identification means can store several identification characteristics that can be stored as data within the device 10 controller 700 and accessible through the HMI 701 including, but not limited to, manufacturing date, perishable date, material type, total volume, volume remaining, manufacturer authentication, and other similar items.

The cartridge 300 of the disclosure can be provided in alternate embodiments, wherein some specific features can be provided in alternate configurations. Accordingly, the cartridge 300 gate valve 305 can be replaced with a duckbill 350 styled valve adapted for a general hinged opening to deliver powder to the container 400. Alternately, the cartridge 300 could be provided without the vertical shaft member 304, wherein powder is delivered through the principles of mass flow.

During production of the cartridge 300 to ease in the filling of powdered material into the cartridge interior cavity 310 it is desired that the vertical shaft member 304 be positioned within the cavity 310 and engaged with the lower surface 312 during filling. After filling, the cap 303 is placed onto the housing 301 upper surface 311 engaged with the vertical shaft member 304 and sealing the cartridge 300.

The container 400 of the device 10 is generally and specifically adapted for use with the device 10. The container 400 is preferably cylindrical and having an upper portion 401 and a lower portion 402 opposite the upper portion 401. The upper portion 401 having a lid 410 adapted for removable coupling with the dispensing system 200 of the device 10, wherein the powder of a cartridge 300 is mixed with a fluid and reconstituted into the container 400 for consumption. The lower portion 402 including a plurality of mixing/stirring blades 420 adapted for magnetic coupling with a magnetic drive element 500 positioned on a lower portion of the device 10, wherein the container is coupled to the magnetic drive element 500 and rested upon it during engagement with the dispenser 200 of the device 10. The magnetic drive element 500 coupled to the controller 700 of the device and accessible through the HMI 701 wherein stirring/mixing can be selected by a user of the device 10.

The device 10 includes a fluid delivery system 600, the fluid delivery system 600 in coupled communication with a fluid source, such as a water source provided from a reservoir 601 placed within the housing 100. The reservoir 601 generally insulated through an insulating material 610. The reservoir 601 in fluid coupling with a cooling assembly 602. The cooling assembly 602 generally adapted to cool a fluid through a heat exchange system 620 preferably including a thermoelectric device (TED) 621 utilizing the Peltier effect to cool a fluid for delivery to the container 400. The fluid delivery system 600 including a pump 603 coupled to the cooling assembly 602 and fluid source 601 to generally circulate and deliver fluid to the container 400. The fluid system 600 coupled to the controller 700 and accessible though the HMI 701, wherein a user may specify a given temperature or range of temperatures for a given dispensed beverage within the container 400.

The device 10 of the present disclosure generally operated through a controller 700 adapted to control the device 10 machine and electronic systems and coupled with the various systems of the device 10 and including a coupling to the HMI 701. The controller 700 in coupled communication with a sensor 702, the sensor 702 adapted to communicate with the cartridge 300 identification means 306, wherein cartridge 300 data is communicated and displayed through the HMI 701. Preferably, the HMI 701 is a touch capacitive enabled screen with various menus associated with the device 10, and more particularly, with the selection of dispensing powders from various cartridges 300 within the dispensing system 200. A data store 703 is coupled to the controller 700 and adapted to store the various and unique properties of a given material within a cartridge 300 and utilized for the handling of the various and unique material properties associated with a given powder within a cartridge 300.

In use of the device 10, a user will utilize the HM 701 touch capacitive enabled screen to select a fruit or vegetable type within the cartridge 300 that the machine 10 will dispense into the container 400. Accordingly, a user is able to create a unique juice beverage from the various installed cartridges 300 and select the percentage of powder dispensed representing a given fruit or vegetable. For example, a user may utilize the machine 10 HMI 701 to select a juice beverage that is 20% carrot, 20% strawberry, 30% banana, and 30% kale. The device 10 controller 700 will then direct the dispensing system 200 to measure the appropriate amount of powdered concentrate from each cartridge 300 to add to container 400 with the addition of fluid from the fluid system 600 to create the juice beverage.

The cartridges 300 coupled communication with the sensor 702 is generally in communication with the HMI 701, wherein the amount of powder in a given cartridge 300 is known and recalculated after use. Accordingly, the cartridge 300 and dispensing system 200 coupling allows for a metering of the internal contents to ensure the proper amount of powder is added to a given and selected beverage. Additionally, due to the inherent properties of powders and variances in given powders for various fruits and vegetables, the cartridges 300 are capable of being manipulated or agitated within the dispensing system 200 to ensure a consistent flow of powder in to the container.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the specification, the claims, and the drawings.

What is claimed is:

1. A machine for use in forming a beverage from a powder, the machine comprising:
a fluid delivery system;
a dispensing system including a cartridge, the cartridge having a cavity for the placement of the powder;
a container, the container having a volume for the placement of a fluid from the fluid delivery system and the powder from the cartridge; and
a blending system, the blending system in communication with the container and adapted to agitate the fluid and powder within the container.

2. A machine as in claim 1, wherein the machine includes a plurality of cartridges.

3. A machine as in claim 2, wherein the cartridge includes a vertical shaft member, the vertical shaft member having a helical screw blade, the helical screw blade adapted to move the powder within the cartridge.

4. A machine as in claim 2, wherein the machine includes a controller and human machine interface, the human machine interface allowing a user to select a given cartridge for dispensing the powder.

5. A machine as in claim 4, wherein the human machine interface allows a user to select the contents of more than one cartridge for dispensing the powder from more than one cartridge of the machine.

6. A machine system for dispensing a powder from a cartridge removably received within the machine; the system comprising:
a fluid dispensing system;
a sensor, the sensor in communication with the cartridge, the cartridge including an identification means;
a dispensing system in communication with the cartridge;
a container, the container including a mixing bar, the container adapted for removable coupling from the dispensing system;
a blending system, the blending system in communication with the mixing bar;
a human machine interface;
a controller in operable communication with the sensor, cartridge, fluid system, dispensing system, and the human machine interface, the controller configured to:
allow for the selection of a cartridge for dispensing though the human machine interface;
direct the fluid dispensing system to add a volume of fluid to the container;
direct the dispensing system to dispense a given volume of powder from the cartridge; and
direct the blending system to operate the blending bar for mixing the volume of powder and fluid within the container.

7. A machine system as in claim 6, wherein the machine system includes a plurality of cartridges.

8. A machine system as in claim 7, wherein the controller is configured to:
allow for the selection of more than one cartridge for dispensing though the human machine interface;
direct the fluid dispensing system to add a volume of fluid to the container;
direct the dispensing system to dispense a given volume of powder from more than one of the plurality of cartridges; and
direct the blending system to operate the blending bar for mixing the volume of powder and fluid within the container.

9. A method for reconstituting a powdered material into a beverage on a machine, the machine including a cartridge, the cartridge containing the powder, the method comprising:
utilizing a human machine interface to select a cartridge;
dispensing a volume of powder from the cartridge into a container;
dispensing a volume of fluid into the container; and
mixing the contents within the container.

10. A method as in claim 9, wherein the machine includes more than one cartridge, the method comprising:
utilizing a human machine interface to select more than one cartridge;
dispensing a volume of powder from more than one cartridge into a container;
dispensing a volume of fluid into the container; and
mixing the contents within the container.
